(19) United States
(12) Patent Application Publication
(10) Pub. No.: US 2012/0327444 A1
(43) Pub. Date: Dec. 27, 2012

(54) IMAGE FORMING APPARATUS

(75) Inventors: Yusuke KAWANAGO, Tokyo (JP); Takahiro OKUBO, Tokyo (JP); Masahiro MATSUO, Tokyo (JP); Tarou MIYAMOTO, Toyokawa-shi (JP); Osamu YOSHIMURA, Toyokawa-shi (JP); Kunihiro KAWACHI, Tokyo (JP); Ken NONAKA, Tokyo (JP)

(73) Assignee: KONICA MINOLTA BUSINESS TECHNOLOGIES, INC., Tokyo (JP)

(21) Appl. No.: 13/527,834

(22) Filed: Jun. 20, 2012

(30) Foreign Application Priority Data
Jun. 23, 2011 (JP) 2011-139182

(51) Int. Cl. G06K 15/02

(52) U.S. Cl. 358/1.13

(57) ABSTRACT

Disclosed is an image forming apparatus including: an image forming unit to form an image on a paper in an image forming position; a transportation path to transport the paper to the image forming position; an acquisition unit arranged upstream of the image forming position in a paper transportation direction and to acquire a shift amount from an edge reference position to an edge of the paper in a paper width direction perpendicular to the paper transportation direction; a pair of resist rollers arranged upstream of the acquisition unit in the paper transportation direction and capable of swinging in the paper width direction; and a control unit configured to determine an instruction value based on a paper state and the shift amount before the pair of resist rollers moves, and to move the pair of resist rollers in accordance with the instruction value in the paper width direction.

### CROSS-REFERENCE TO RELATED APPLICATION

This application is based on Japanese Patent Application No. 2011-139182 filed on Jun. 23, 2011, the contents of which are incorporated herein by reference.

### BACKGROUND

1. Technical Field

The present invention relates to an image forming apparatus provided with a function of swinging in a paper width direction which is perpendicular to a paper transportation direction in a state where a paper is sandwiched, before transporting the paper to an image forming position.

2. Description of Related Arts

Conventionally, when a paper which is one of a recording medium is transported to an image forming position from a paper feeding unit, paper may shift toward one side in a paper width direction which is perpendicular to a paper transportation direction. Causes of this matter are, for example, nonuniformity of a diameter of a roller in a longitudinal direction thereof due to an error at the time of manufacturing roller transporting paper, change of diameter of roller due to aged deterioration of roller, or shift of paper loaded in paper feeding unit to one side. Thus, when shift has occurred toward width direction of paper, a problem will be realized in that an image is formed in a position which is different from a position desired by a user, when performing image formation.

A resist swing is known as a manner for solving the above-mentioned problem, in other words, in, as a manner of accurately aligning image and paper by considering shift of paper.

One example of resist swing is disclosed in Unexamined Japanese Patent Publication No. 2007-22680. The Publication discloses a pair of resist rollers arranged before an image forming position, and a photo sensor arranged in a vicinity of downstream side of pair of resist rollers in a transportation direction of paper. Specifically, a pair of resist rollers can swing in a paper width direction in a state where paper is sandwiched, and move in paper width direction according to a shift amount of paper acquired by a photo sensor, in the state where paper is sandwiched. According to such operation, a shift of paper in paper width direction is compensated for so that an image and a paper are aligned.

At the time of resist swing, a pair of resist rollers is caused to move according to an instruction value which is set to above-mentioned shift amount, however there is a difference in this instruction value and actual measured value which is a move amount of paper moved by resist swing. Therefore, there is a problem in that it may be difficult to accurately align image and paper.

### SUMMARY

The present invention is made in view of above-described circumstances, and provides an image forming apparatus having a function of swing in a paper width direction in a state where a paper is sandwiched, and is capable of aligning an image and the paper accurately.

To achieve at least one of the above-mentioned objects, an image forming apparatus reflecting one aspect of the present invention includes an image forming unit, a transportation path, an acquisition unit, a pair of resist rollers, and a control unit. The image forming unit forms an image on a paper in an image forming position. The transportation path transports the paper to the image forming position. The acquisition unit is arranged on an upstream side of the image forming position in a paper transportation direction, and acquires a shift amount from an edge reference position to an edge of the paper in a paper width direction, perpendicular to the paper transportation direction. The pair of resist rollers is arranged on the upstream side of the acquisition unit in the paper transportation direction, and is capable of swinging in the paper width direction. The control unit determines an instruction value based on a state of the paper and the shift amount before the pair of resist rollers moves, and performs a control in which the pair of resist rollers is moved in accordance with the instruction value in the paper width direction.

The objects, features, and characteristics of this invention, other than those set forth above, will become apparent from the description given herein below with reference to preferred embodiments illustrated in the accompanying drawings.

### BRIEF DESCRIPTION OF THE DRAWINGS

FIG. 1 is a schematic diagram of an image forming apparatus 1.

FIG. 2 is a block diagram illustrating electric constitution of the image forming apparatus 1.

FIG. 3 is an explanatory diagram regarding when an acquisition unit 90 acquires a shift amount ΔX of paper P.

FIG. 4 is a relationship diagram illustrating a relationship between instruction values and actual measured values in cases where the instruction values are the shift amounts ΔX.

FIG. 5 is a classification diagram in which the paper P is classified into groups according to the state of the paper P in one side printing.

FIG. 6 is a classification diagram in which the paper P is classified into groups according to the state of the paper P in both-sides printing.

FIG. 7 is a diagram illustrating a relationship between shift values and instruction values in one side printing for the paper P classified into groups (1)a, (2)a and (3)a respectively.

FIG. 8 is a flowchart which illustrates a control procedure of a CPU 101 in a first image forming mode.

FIG. 9 is a diagram illustrating an example of a display screen of an operation unit 10 for adjustment of the instruction value.

FIG. 10 is a flowchart which illustrates a control procedure of a CPU 101 in a second image forming mode.

### DETAILED DESCRIPTION

The embodiments of this invention will be described below with reference to the accompanying drawings. Although various limitations which may be technically preferable are provided in the present embodiments described below for working of the present invention, the scope of invention is not limited to the following embodiments and drawings. Moreover, the dimensional ratios in the drawings are exaggerated for the sake of explanation, and may be different from actual ratios. Moreover, unless otherwise stated, a paper width direction described below is a direction which is perpendicular to a paper transportation direction D and is along a width of the paper, the paper transportation direction D being a direction of movement of the paper through the transport unit 70 or the re-transport unit 80, which are described below.

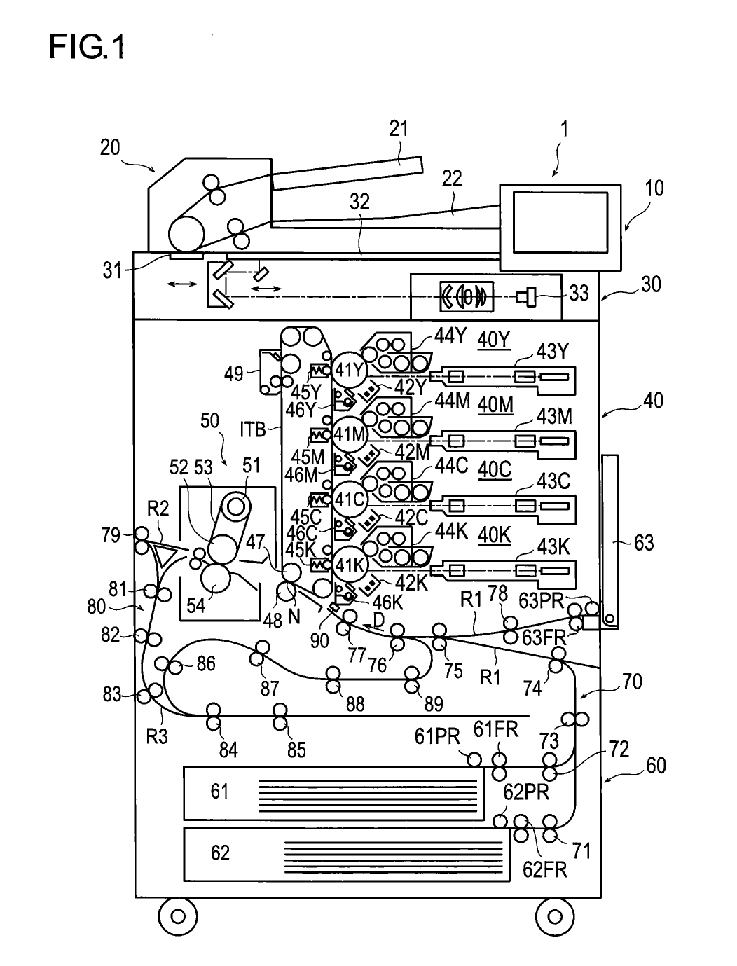

FIG. 1 is a schematic diagram of an image forming apparatus 1 reflecting one aspect of the present invention.

The image forming apparatus 1 can include an operation unit 10, an automatic document feeding unit 20, a reading unit 30, an image forming unit 40, a fixing unit 50, a paper feeding unit 60, a transport unit 70, a re-transport unit 80, and an acquisition unit 90.

The operation unit 10 includes a touch panel, a numeric keypad, various kinds of selection buttons and decision buttons and the like, which are integrated with a display panel such as an LCD (Liquid Crystal Display). The user can operate the operation unit 10 to perform settings regarding a printing action such as a document setting, an image quality setting, a magnification setting, an application setting, an output setting, a one side/both-sides setting, a paper setting, and moving amount adjustment. More details of the operation unit 10 will be described below.

The automatic document feeding unit 20 is also called an ADF (Auto Document Feeder), and includes a paper feed tray 21 for the ADF and a discharge tray 22 for the ADF. The automatic document feeding unit 20 is an apparatus which automatically feeds the document in order to read the document. The document set on the paper feed tray 21 for the ADF is transported to a position of a slit glass 31 for document reading of the reading unit 30 (which will be described below), for example, upon the decision button of the operation unit 10 being pushed, and the image data of the document is read. Then, the document is discharged to the discharge tray 22 for the ADF.

The reading unit 30 includes the slit glass 31 for document reading, a platen glass 32, CCD (Charge Coupled Device) 33, a plurality of lenses and a light source. The reading unit 30 acquires the image data of the document transported from the paper feed tray 21 for the ADF to the slit glass 31 for document reading, or the document placed on the platen glass 32.

Specifically, in the case of using the automatic document feeding apparatus 20, a document sheet is transported one-by-one from a sheaf of documents placed on the paper feed tray 21 for the ADF to the slit glass 31 for document reading of the reading unit 30. Then, the light source irradiates the document and the CCD 33 receives reflected light from the document to thereby read the image data of the document. On the other hand, in cases where a document is on the platen glass 32, the light source irradiates the document and the CCD 33 receives the reflected light from the document to thereby read the image data of the document. The image data acquired in this way is stored in the hard disk 104, which will be described below.

The image forming unit 40 includes a first image forming unit 40Y which forms the image of a yellow color, a second image forming unit 40M which forms the image of a magenta color, a third image forming unit 40C which forms the image of a cyan color, and a fourth image forming unit 40K which forms the image of a black color. Moreover, the image forming unit 40 also includes an intermediate transferring belt ITB which serves as a holding unit holding the image formed by the first image forming unit 40Y to the fourth image forming unit 40K, a first nip generation roller 47 and a second nip generation roller 48 which form a nip section N for transferring the image on the intermediate transferring belt ITB to the paper P, and a cleaner unit 49 which collects the toners remaining on the intermediate transferring belt ITB after the transfer.

The fixing unit 50 includes a heating roller 51, a fixing roller 52, a fixing belt 53 stretched by the heating roller 51 and the fixing roller 52, and a pressing roller 54 arranged in a position facing the fixing roller 52 through the fixing belt 53.

Hereinafter, the electrophotographic manner in which the image forming unit 40 and the fixing unit 50 forms the image on the paper P will be explained. Since the first image forming unit 40Y through the fourth image forming unit 40K achieve similar functions, explanation is consolidated on behalf of the first image forming unit 40Y.

The first image forming unit 40Y includes a photosensitive drum 41Y, a charging means 42Y, an exposure means 43Y, a development means 44Y, a transfer means 45Y, and a cleaning means 46Y. In the case of forming the image of a yellow color, the photosensitive drum 41Y charged by the charging means 42Y is subjected to an exposure scanning by a laser beam emitted from the exposure means 43Y based on the image data. Thereby, an electrostatic latent image is formed on the photosensitive drum 41Y. Subsequently, the photosensitive drum 41Y adsorbs the toner of a yellow color by the development means 44Y, and transfers the image to the intermediate transferring belt ITB by the transfer means 45Y (primary transfer).

Then, images of respective colors formed by the second image forming unit 40M, the third image forming unit 40C, and the fourth image forming unit 40K respectively are superimposed onto the image of the yellow color on the intermediate transferring belt ITB. The image superimposed in this way is forwarded to the nip section N in a state in which the image is held on the intermediate transferring belt ITB, and is transferred onto the paper P transported from the paper feeding unit 60 which is described below (secondary transfer). Then, the fixing unit 50 applies heat and pressure to this paper P, and fixes the image on the paper P.

The paper feeding unit 60 includes a plurality of paper trays 61-63, which serves as a storage unit, for storing the various papers P, pickup rollers 61PR-63PR for feeding papers P from respective paper trays, and flip-through rollers 61FR-63FR for preventing double transportation of the paper P from respective paper trays. The paper tray 63 is a hand feed paper tray. Note that the number of paper trays is not limited to three. Moreover, one or more of high-capacity feeding apparatus which can store the large amount of papers P may be provided, if necessary.

The transport unit 70 has a transportation path R1 from each of the paper trays 61, 62 and 63 to the nip section N, a discharge transportation path R2 for discharging the paper P from the fixing unit 50 outside the image forming apparatus 1a, and a plurality of pairs of transport rollers 71-79. The paper P fed from the paper feeding unit 60 is transported to the nip section N by the pairs of transport rollers required for the transportation among the pairs of transport rollers 71-78 on the transportation path R1, and is subjected to the secondary transfer. Then, the paper P is transported to the fixing unit 50 and is subjected to the fixing by the fixing unit 50. In the case of discharging the paper P in which the image has been fixed by the fixing unit 50 outside the apparatus, the pairs of transport rollers 79 on the discharge transportation path R2 discharges the paper P outside the machine.

The pair of transport rollers 76 among the pairs of transport rollers 71-79 is a pair of rollers for forming a loop in the paper P by striking the paper P during transportation against the pair of transport rollers 77, and is called as a pair of loop generation rollers. Hereinafter, the pair of transport rollers 76 is referred to as the pair of loop generation rollers 76. Moreover, the pair of transport rollers 77 is a pair of rollers which can be swung in the paper width direction in a state where the paper P is sandwiched, and is called as a pair of resist rollers. Hereinafter, the pair of transport rollers 77 is referred to as the pair of resist rollers 77. The pair of loop generation rollers 76 and the pair of resist rollers 77 includes mechanism for pressing contact and releasing of the pressing contact of the pair of rollers. This mechanism is provided with, for example, a cam which touches a roller axis and a motor for rotating the cam. The detailed explanation thereof is omitted since it is well-known.

The re-transport unit 80 includes a re-transportation path R3 for circulating the paper P sent out from the fixing unit 50 in the image forming apparatus 1 to transport the paper to the nip section N again, pairs of re-transport rollers 81-89 as a plurality of pairs of re-transport rollers, the pair of loop generation rollers 76, and the pair of resist rollers 77.

The acquisition unit 90 is provided with a sensor such as a line sensor in which photoelectric conversion elements are arranged in a line, or an image sensor in which the photoelectric conversion elements are arranged in a matrix. The acquisition unit 90 is located in the upstream side of the nip section N, which is the image forming position, in the paper transportation direction D and is located on the downstream side of the pair of resist rollers 77. In other words, the acquisition unit 90 is provided on the transportation path R1 between the nip section N and the pair of resist rollers 77. The acquisition unit 90 acquires the shift amount ΔX from the edge reference position mentioned below to the edge of the paper P with respect to the paper P transported from the pair of resist rollers 77. The details thereof will be described below. The shift amount ΔX acquired by the acquisition unit 90 is used for deciding the instruction value at the time of performing the resist swing by the pair of resist rollers 77. The resist swing here represents the move in the paper width direction in a state where the pair of resist rollers 77 sandwiches the paper P.

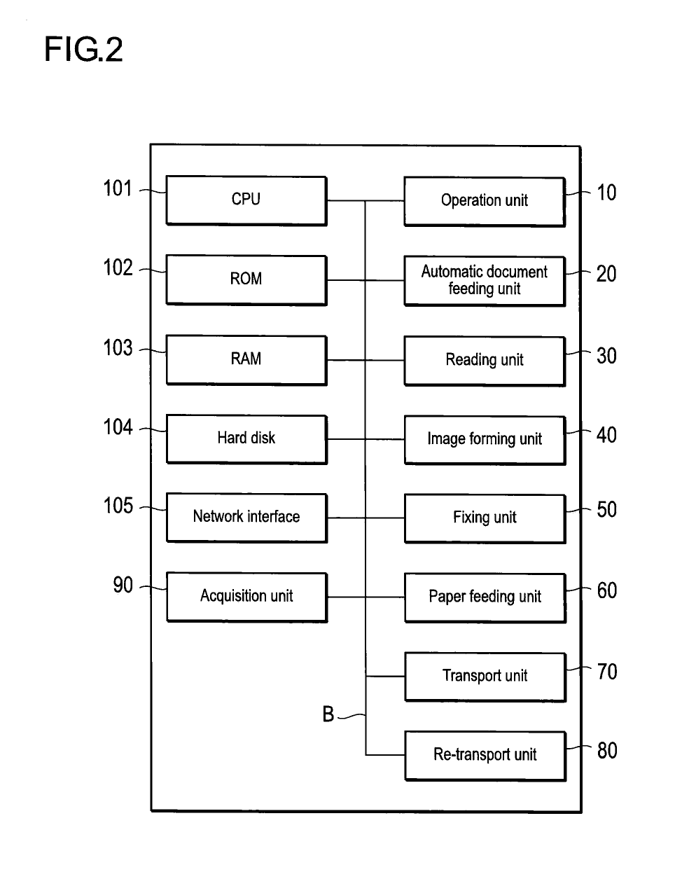

FIG. 2 is a block diagram illustrating an embodiment of the electric constitution of the image forming apparatus 1.

The image forming apparatus 1 includes a CPU (Central Processing Unit) 101, ROM (Read Only Memory) 102, RAM (Random Access Memory) 103, a hard disk 104, a network interface 105, the operation unit 10, the automatic document feeding unit 20, the reading unit 30, the image forming unit 40, the fixing unit 50, the paper feeding unit 60, the transport unit 70, the re-transport unit 80, and the acquisition unit 90. These elements are connected through a bus B with each other.

The CPU 101 performs a control of each of above-described elements, and various kinds of calculation processes according to programs. That is, the CPU 101 corresponds to the control unit of the present invention. As an example, the CPU 101 determines the instruction value at the time of performing the resist swing by the pair of resist rollers 77 based on an instruction value decision program stored in the ROM 102 or in the hard disk 104.

The ROM 102 stores various programs and various data. The RAM 103 serves as a workspace to temporarily store programs and data. The hard disk 104 stores various programs including an operating system, and various data. The programs stored in above-described ROM 102 or hard disk 104 may be, for example, a program for translating PDL data received from a personal computer to generate the image data in the form of bit map, and a program for editing or processing the stored image data in the form of bit map.

The network interface 105 includes various interfaces such as NIC (Network Interface Card), MODEM (Modulator-DEModulator), and USB (Universal Serial Bus), and connects with an external device. For example, the network interface 105 can be connected with the personal computer which is the external device, and receives the PDL (Page description Language) which is a page description language from the personal computer. In addition, a plurality of external devices to be connected may be provided, and the external devices may be, for example, a multifunction printer, a printer, a print server and the like other than the personal computer.

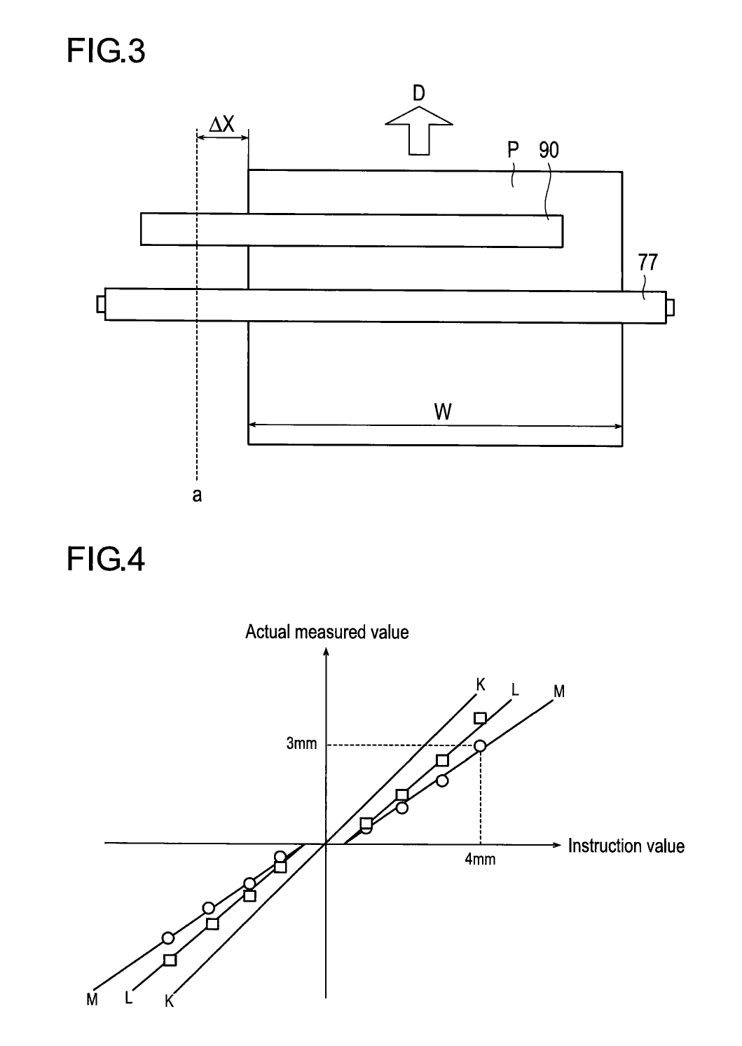

FIG. 3 is an example explanatory diagram relate to a condition when the acquisition unit 90 acquires a shift amount ΔX of the paper P. In FIG. 3, the paper width W is a width of the paper P in the paper width direction. The edge reference position a is an imaginary line which represents a reference position for the edge of the paper P, and is positioned on left side to the paper transportation direction D when viewed from above the image forming apparatus 1. The shift amount ΔX is the shortest distance between the edge reference position a which represents an edge reference position and the paper P. That is, the shift amount ΔX represents how far the paper P is shifted against the edge reference position a. In the present embodiment, in cases where the shift amount ΔX is plus, the shift amount ΔX represents that the paper P is shifted to the right side of the edge reference position to the paper transportation direction D. On the other hand, in cases where the shift amount ΔX is minus, the shift amount ΔX represents that the paper P is shifted to the left side of the edge reference position to the paper transportation direction D.

Next, with reference to FIG. 4, it will be explained that, when setting the instruction value to the shift amount ΔX and making the pair of resist rollers 77 move by the instruction value, a difference has occurred between the instruction value and actual measured value which is the “move amount” of the paper moved by the resist swing. Note that the actual measured values in FIG. 4 are values acquired by the acquisition unit 90 after the resist swing.

FIG. 4 is a relationship diagram illustrating a relationship between instruction values and actual measured values in cases where the instruction values are set to the shift amounts ΔX. The horizontal axis represents the instruction values and the vertical axis represents the actual measured values. The solid line K in the drawing represents a line in the case where the instruction values and the actual measured values are equal. It is preferable that the instruction values and the actual measured values are equal as shown by the solid line K, but in fact, the instruction values and the actual measured values do not match.

The plots with the square and the plots with the circle illustrated in FIG. 4 represent relationships between the instruction values and the actual measured values in cases where the grammage of the paper is changed under a condition that humidity and paper size are constant, in the image forming apparatus 1. Moreover, the solid line L and the solid line M are linear approximated curves of respective plots. Specifically, the solid line L represents the linear approximated curve of a plain paper (for example, the grammage is 100 g/m²), and the solid line M represents the linear approximated curve of a thick paper (for example, the grammage is 200 g/m²). The inventors of the present invention found that the difference between the instruction value and the actual measured value increases as the grammage increases. Moreover, the inventors of the present invention found that, in cases where paper size is changed under a condition that the humidity and the grammage are constant, the difference between the instruction value and the actual measured value increases as the paper size increases. In addition, the inventors of the present invention found that, in cases where the humidity is changed under a condition that the paper size and the grammage are constant, the difference between the instruction value and the actual measured value increases as the humidity increases. Furthermore, the inventors of the present invention found that, even if all conditions of the humidity, the grammage and the paper size are constant, the instruction value and the actual measured value are different between a case of performing the image formation on only a first side of the paper P in one side printing and a case of performing the image formation also on a second side which is a back side of the first side of the paper P in cases of both-side printing. Without being bound by theory, from these experimental results, the inventors of the present invention ascertained that the reason of the mismatch between the instruction value and the actual measured value relies on the state of the paper P. For example, frictional force generated between the paper P and the transportation path which contacts the paper P (for example, the transportation path R1 or the re-transportation path R3) at the time of the resist swing can affect the difference between the instruction value and the actual measured value.

For example, in cases where the grammage of the papers (as the state of the papers P) is different from each other, the frictional force between the paper and the transportation path increases as the grammage increases, and the frictional force becomes a resistance at the time of performing the resist swing. Moreover, in cases where the paper sizes (as the state of the papers P) are different from each other, the frictional force increases as the contact area between the paper P and the transportation path increases, and the frictional force becomes a resistance at the time of performing the resist swing. In cases where the ambient humidity (as the state of the papers P) are different from each other, the frictional force increases as the humidity increases, since the amount of moisture included in the paper increases. The frictional force becomes a resistance at the time of performing the resist swing. Moreover, the state of the paper P may be a shape of the paper P at the time of acquiring the shift amount ΔX by the acquisition unit 90. That is, at the time of the resist swing, the frictional force changes depending on whether the paper P is located on the transportation path R1 or on the re-transportation path R3. For example, the transportation path R1 and the re-transportation path R3 join together in the vicinity of the transportation roller 76 in the image forming apparatus 1. Here, with respect to the shapes of the transportation paths before joining, the curvature of the re-transportation path R3 is larger than the curvature of the transportation path R1. Therefore, in comparison with the case of performing the resist swing for the first side of the paper P in one side printing, the paper P is more greatly bent in the case of performing the resist swing for the second side of the paper P in both-sides printing. Thus, the contact with the paper P and the re-transportation path R3 becomes strong by the elasticity of the paper P. As a result, the frictional force between the paper P and the re-transportation path R3 is higher, in comparison with the frictional force between the paper P and the transportation path R1. Accordingly, if the shapes of the paper P at the time of acquiring the shift amount ΔX by the acquisition unit 90 are different, the frictional force changes.

Thus, the state of the paper P may be the humidity, the grammage, the paper size and the shape of the paper P at the time of acquiring the shift amount ΔX by the acquisition unit 90 as described above. However, for the sake of a concise illustration, a case using three of the paper size, the grammage and the shape of the paper P at the time acquiring the shift amount ΔX by the acquisition unit 90 will be explained below.

FIG. 5 is a classification diagram in which the papers P are classified into groups according to the state of the papers P in one side printing. Specifically, the papers P are classified into three groups (1)a, (2)a and (3)a according to the grammage and the paper size, in the case of performing the image formation only on the first side of the paper P in one side printing.

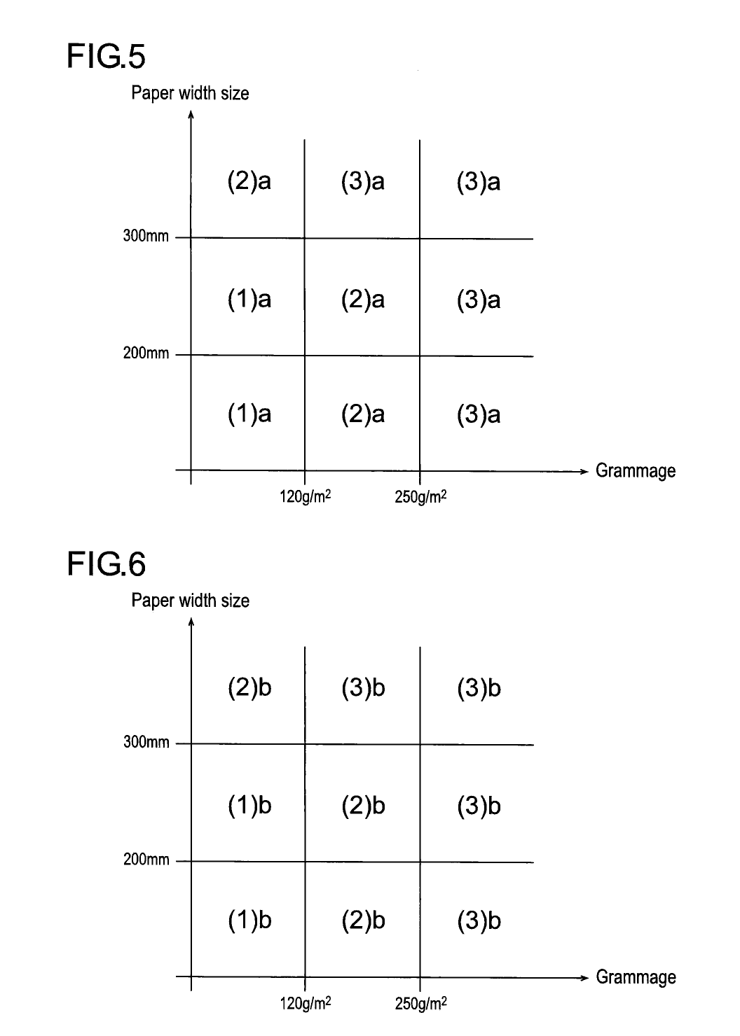

Similarly, FIG. 6 is a classification diagram in which the papers P are classified into groups according to the state of the papers P in both-sides printing. Specifically, the papers P are classified into three groups (1)b, (2)b and (3)b according to the grammage and the paper size, in the case of performing the image formation on the second side which is a back side of the first side of the paper P in both-sides printing. Note that the three groups (1) a, (2) a and (3) a are applied in the case of performing the image formation on the first side of the paper P in both-sides printing.

The paper size in FIG. 5 and FIG. 6 represents the size of the paper P in the paper width direction (paper width size). However, the paper size is not limited to this size and may be a size of the paper P in the paper transportation direction D, for example. Moreover, in one side printing and both-sides printing, the paper width size is divided at 200 mm and 300 mm, and the grammage is divided at 120 g/m² and 250 g/m², but these dividing positions may be arbitrarily changed in accordance with a specification of the apparatus.

Next, a relationship between the shift amount ΔX of the paper P and the instruction value in each above-mentioned group will be described. The data of the instruction value corresponding to the shift amount ΔX is stored in advance, for example in the hard disk 104. That is, the hard disk 104 corresponds to the memory unit of the present invention. In the following explanations, only one side printing will be explained since the explanations for the one side printing and both-sides printing overlap.

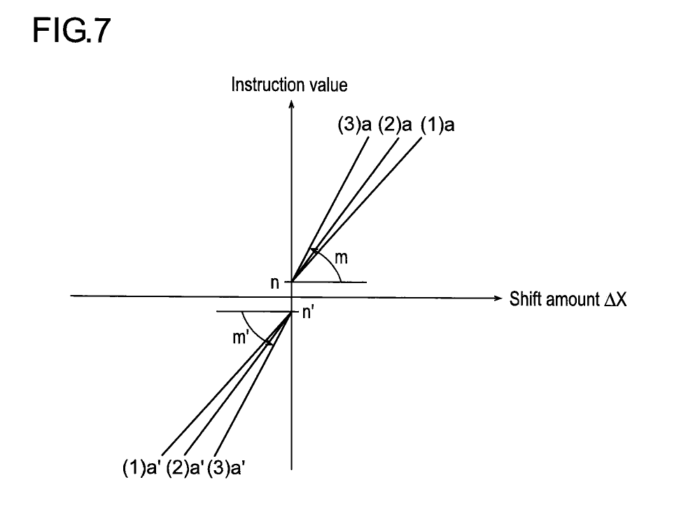

FIG. 7 is a diagram illustrating a relationship between shift values and instruction values in one side printing for the papers P classified into groups (1)a, (2)a and (3)a respectively. The intercept n and the intercept n′ in the drawing has values, for example, defined by fluctuation of an actuator which drives the pair of resist rollers 77.

First, an upper right area of FIG. 7 will be explained. In this area, since the shift amount ΔX is plus, the paper P is shifted on the right of the edge reference position to the paper transportation direction D. Therefore, at the time of the resist swing, the pair of resist rollers 77 moves a distance corresponding to the instruction value in the state where the paper P is sandwiched, toward a direction such that the paper P is returned to the edge reference position (toward left to the paper transportation direction D). The instruction value here is different from the shift amount ΔX, and is larger than the shift amount ΔX. Specifically, as for the line corresponding to each of (1)a, (2)a and (3)a, the instruction values are larger than the shift amounts ΔX. Moreover, with respect to (1)a, (2)a and (3)a, the frictional force generated between the paper P and the transportation path R1 increases as the number increases. Thus, the slope m of the line corresponding to each of (1)a, (2)a and (3)a becomes heavy, as the number increases.

Next, a lower left area of FIG. 7 will be explained. In the lower left area of FIG. 7, since the shift amount ΔX is minus, the paper P is shifted along the paper width direction on the left of the edge reference position to the paper transportation direction D. Therefore, at the time of the resist swing, the pair of resist rollers 77 moves a distance corresponding to the instruction value, in the state where the paper P is sandwiched, toward a direction such that the paper P is returned to the edge reference position (toward right to the paper transportation direction D). The instruction value here is different from the shift amount ΔX, and is larger than the shift amount ΔX. Specifically, as for the line corresponding to each of (1)a′, (2)a′ and (3)a′, absolute values of the instruction values are larger than absolute values of the shift amounts ΔX. Moreover, with respect to (1) a′, (2) a′ and (3) a′, the frictional force generated between the paper P and the transportation path R1 increases as the number increases. Thus, the slope m of the line corresponding to each of (1)a′, (2)a′ and (3)a′ becomes heavy, as the number increases.

As described above, in the image forming apparatus 1, in cases where the shift amount ΔX is minus, groups (1)a, (2)a and (3)a are not applied as groups of the papers P but, groups (1)a′, (2)a′ and (3) a′ are applied as groups of the papers P. This is because the direction, in which the pair of resist rollers 77 moves, changes whether the shift amount ΔX is plus or minus. That is, the (1) a′, (2) a′ and (3)a′ are taken into consideration that the frictional force between the paper P and the transportation path changes due to a change of the direction in which the pair of resist rollers 77 moves. Note that the present invention is not limited to this manner, and the same groups of the papers P may be applied in both cases where the shift amount ΔX is plus and is minus.

Thus, in the image forming apparatus 1, the instruction value is determined in accordance with the state of the paper P and the shift amount ΔX. Therefore, in comparison with the case where the pair of resist rollers 77 is made to move by setting the shift amount ΔX itself into the instruction value (the case where the state of the paper P is not considered), the difference between the shift amount ΔX and the instruction value decreases. As a result, it is possible to provide the image forming apparatus capable of aligning the image and the paper accurately.

Next, two image forming modes will be described, which can be a function of the image forming apparatus 1, for adjusting the instruction value. Such image forming modes are stored in the ROM 102 or the hard disk 104 as the instruction value decision program. The difference in the two image forming modes is an adjustment manner for the instruction value m.

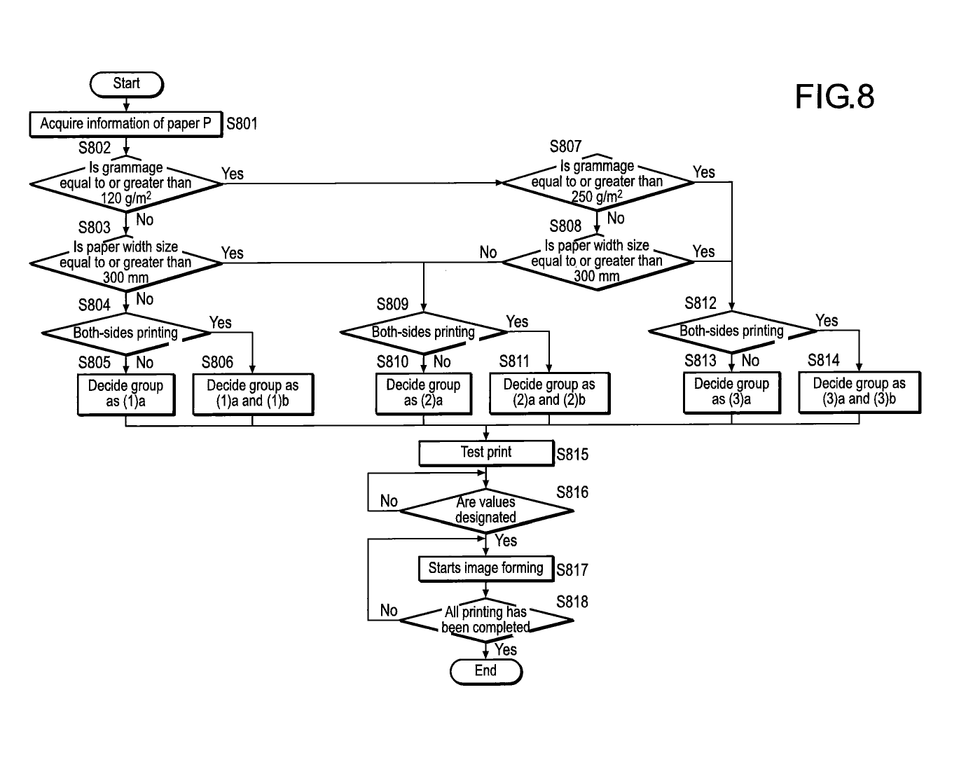

FIG. 8 is a flowchart which illustrates a control procedure of the CPU 101 in a first image forming mode. In the first image forming mode, adjustment of instruction value is manually performed by the user.

First, the CPU 101 acquires the information regarding the state of the paper P, when the paper to be used for the image formation is instructed by the user (S801). For example, when the decision button for instructing execution of the image formation to the CPU 101 through the operation unit 10 is pushed by the user, the CPU 101 determines the paper P to be used for the image formation, and acquires the information regarding the state of the paper P from the hard disk 104. Moreover, when the user selects the paper P or the paper feeding unit 60 to be used through the operation unit 10, the CPU 101 may determine the paper P to be used for the image formation, and may acquire the information regarding the state of the paper P from the hard disk 104. In cases where the PDL data is received from the personal computer, the CPU 101 determines the paper P to be used for the image formation from the received PDL data, and acquires the information regarding the state of the paper from the hard disk 104.

The CPU 101 checks whether the grammage is equal to or greater than 120 g/m² (S802). In cases where the grammage is less than 120 g/m² (S802, No), the CPU 101 checks whether the paper width size is equal to or greater than 300 mm (S803). In cases where the paper width size is less than 300 mm in the step S803 (S803, No), the CPU 101 checks whether the both-sides printing or not (S804). In cases where it is determined not both-sides printing but one side printing in the step S804 (S804, No), the CPU 101 determines the group of the paper P as (1)a (S805). On the other hand, in cases where it is determined both-sides printing in the step S804 (S804, Yes), the CPU 101 determines the group of the first side of the paper P as (1)a and the group of the second side of the paper P as (1)b (S806).

In cases where the grammage is equal to or greater than 120 g/m² in the step S802 (S802, Yes), the CPU 101 checks whether the grammage is equal to or greater than 250 g/m² further (S807). In cases where the grammage is less than 250 g/m² (S807, No), the CPU 101 checks whether the paper width size is equal to or greater than 300 mm (S808). In cases where the paper width size is less than 300 mm in the step S808 (S808, No), or in cases where the paper width size is equal to or greater than 300 mm in the step S803 (S803, Yes), the CPU 101 checks whether the both-sides printing or not (S809). In cases where it is determined not both-sides printing but one side printing in the step S809 (S809, No), the CPU 101 determines the group of the paper P as (2)a (S810). On the other hand, in cases where it is determined both-sides printing in the step S809 (S809, Yes), the CPU 101 determines the group of the first side of the paper P as (2)a and the group of the second side of the paper P as (2)b (S811).

In cases where the grammage is equal to or greater than 250 g/m² in the step S807 (S807, Yes), or in cases where the paper width size is equal to or greater than 300 mm in the step S808 (S808, Yes), the CPU 101 checks whether both-sides printing or not (S812). In cases where it is determined not both-sides printing but one side printing in the step S812 (S812, No), the CPU 101 determines the group of the paper P as (3)a (S813). On the other hand, in cases where it is determined both-sides printing in the step S812 (S812, Yes), the CPU 101 determines the group of the first side of the paper P as (3)a and the group of the second side of the paper P as (3)b (S814).

After the CPU 101 determines the group of the paper P as described above, the CPU 101 performs a test print for the adjustment of the instruction value (S815). Then, the CPU 101 waits until the slope m, the slope m′, the intercept n, and intercept n′ for deciding the instruction value are determined by the user through the operation unit 10 (S816). That is, the CPU 101 waits until the adjustment of the instruction value is made by the user. During waiting (S816, No), the user designates the slope m, the slope m′, the intercept n, and the intercept n′ with reference to a result of the test print and a screen displayed on the operation unit 10. The displayed screen on the operation unit 10 for the adjustment of the instruction value will be described below.

In the step S816, when the slope m, the slope m′, the intercept n, and intercept n′ are designated by the user (S816, YES), the CPU 101 controls each element of the image forming apparatus 1, and starts the image formation (S817). The CPU 101 calculates the instruction value based on the value designated in the step S816, at the time of the image formation in the step S817. Then, the CPU 101 checks whether all image formation has been completed (S818). In cases where it is determined that all image forming has not been completed in the step S818 (S818, No), the CPU 101 performs the image formation continuously (S817). On the other hand, in cases where it is determined that all image forming has been completed in the step S818 (S818, Yes), the CPU 101 ends execution of the program regarding the first image forming mode.

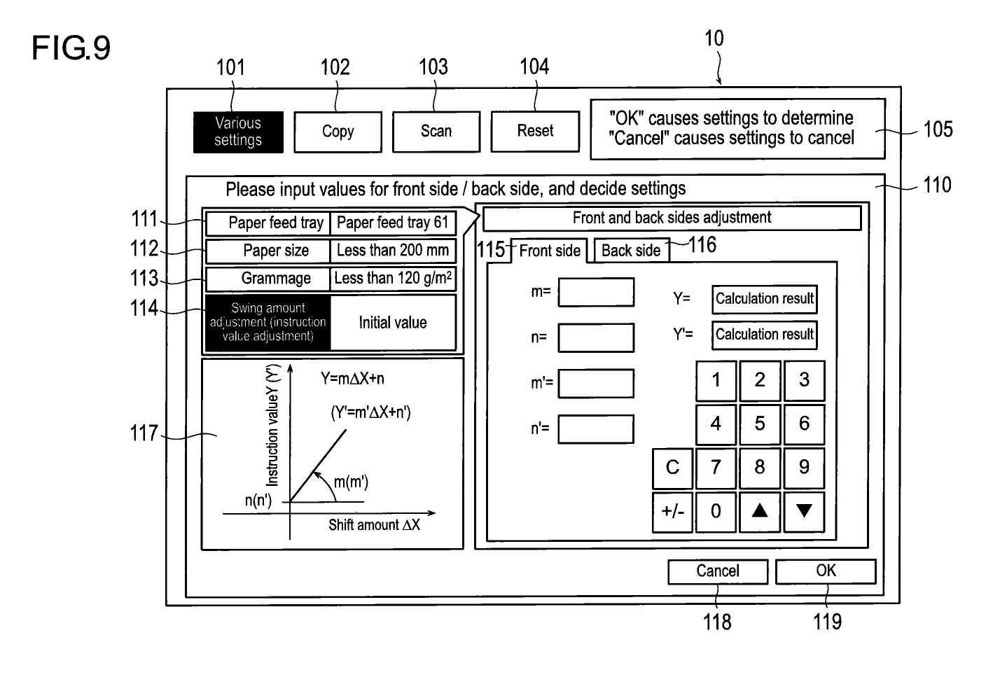

FIG. 9 is a diagram illustrating an example of the display screen of the operation unit 10 for adjustment of instruction value. The operation unit 10 includes a various setting button 101 for performing fundamental setting regarding the image formation, a copy button 102 as a decision button for performing the image formation, a scanning button 103 to scan and fax, a reset button 104 for stopping a copy or a scan and resetting all of settings, a comment field 105 in which comment supporting user's operation is displayed, and a display screen 110 for informing screens according to the situation to a user.

Here, various kinds of items displayed on the display screen 110 in the step S816 of FIG. 8 will be described. These items are displayed by designating the various setting button 101 by the user and then designating a button regarding a setting of the paper feed tray, for example. The display screen 110 includes a paper feed tray designation section 111, a paper size designation section 112, a grammage designation section 113, a swing amount adjusting section (an instruction value adjusting unit) 114, a front-side swing amount adjusting section 115, a back-side swing amount adjusting section 116, an explanation section 117, a cancellation button 118, and an O.K. button 119. The paper feed tray designation section 111 is for designating the paper feed tray to set up. The paper size designation section 112 and the grammage designation section 113 are for setting the paper size and the grammage respectively regarding the paper feed tray designated by the paper feed tray designation section 111. As to these values, rough settings may be applied such as more of a certain value or less than a certain value, or detailed values may be designated.

The swing amount adjusting section 114 is for adjusting the slope m, the slope m′, the intercept n and the intercept n′. That is, the swing amount adjusting section 114 corresponds to the adjusting unit of the present invention. When the swing amount adjusting section 114 is designated by the user, the front-side swing amount adjusting section 115, the back-side swing amount adjusting section 116 and the explanation section 117 are displayed in the display screen 110. Then, for example, the user adjusts the instruction value by the front-side swing amount adjusting section 115 and the back-side swing amount adjusting section 116 with reference to the explanation section 117. In the front-side swing amount adjusting section 115, the user contacts any of areas each located on the right of the slope m, the slope m′, the intercept n and the intercept n′, then inputs values by the numeric keypad located on lower right side. After finishing the input of values, a calculation result is automatically displayed on the area located on the right of “Y” or “Y′.” Then, the user checks whether the adjustment of the instruction value is appropriate using the result as reference. After that, designating the O.K. button 119 causes the slope m, the slope m′, the intercept n, and the intercept n′ to be determined, and the adjustment of the instruction value is finished. On the other hand, when canceling the adjustment of the instruction value, the user designates the cancellation button 118. Moreover, designating the back-side swing amount adjusting section 116 by the user causes the adjustment of the instruction value regarding the second side that is the back side of the first side of the paper P.

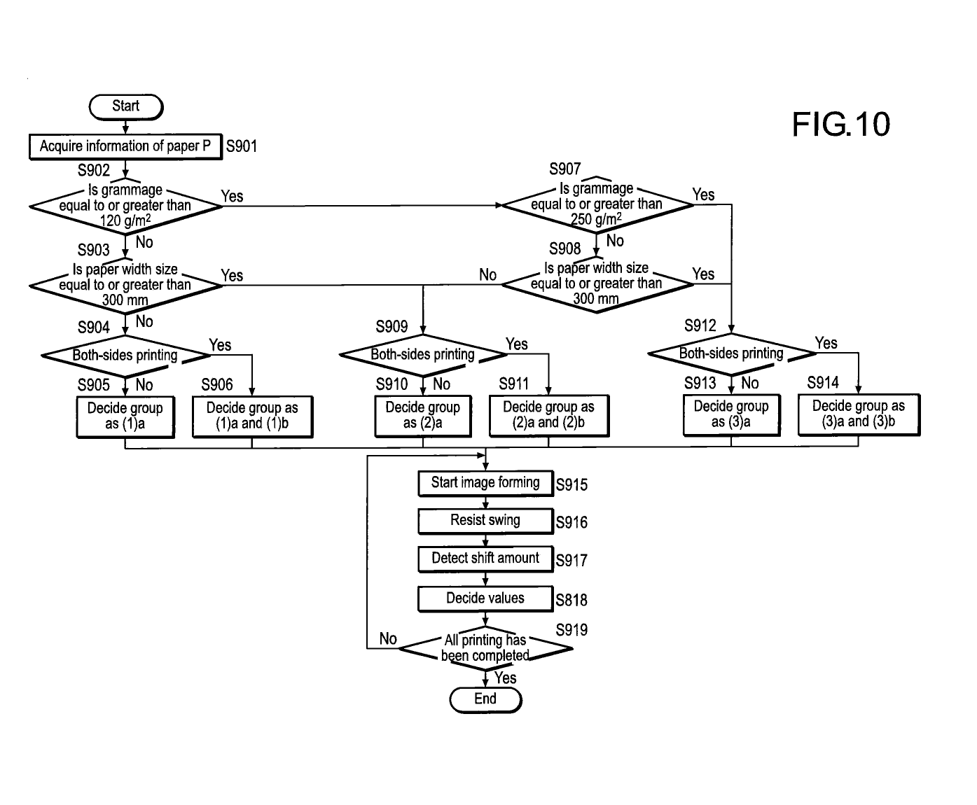

Lastly, the second image forming mode will be described. FIG. 10 is a flowchart which illustrates a control procedure of the CPU 101 in the second image forming mode. In the second image forming mode, the CPU 101 automatically adjusts the instruction value.

Explanation regarding steps S901 to S914 is omitted, since those are same as steps S801 to S814. After deciding the group of the paper P by the CPU 101 in the steps S901 to S914, the CPU 101 performs the image formation for adjusting the instruction value (S915). Then, the CPU 101 performs the resist swing to the paper P transported from the paper feeding unit 60 (S916). After that, the CPU 101 checks the shift amount of the paper P after the resist swing using the acquisition unit 90 (S917). Then, the CPU 101 determines the slope m, the slope m′, the intercept n, and intercept n′ for the paper which will be transported next, from the difference between the instruction value used to the resist swing in the step S916 and the shift amount acquired in the step S917 (S918). That is, the CPU 101 adjusts the instruction value instead of the user. Then, the CPU 101 checks whether all image formation has been completed (S919). In cases where it is determined that all image formation has not been completed in the step S919 (S919, No), the CPU 101 continuously performs the image formation using the instruction value adjusted in the S918 (S915). On the other hand, in cases where it is determined that all image formation has been completed in the step S919 (S919, Yes), the CPU 101 ends execution of the program regarding the second image forming mode.

Thus, the image forming apparatus 1 can adjust the instruction value manually or automatically. Therefore, even if the instruction value is incorrect, it is possible to increase accuracy of alignment of the image and the paper. In the case of manually adjusting the instruction value, it is possible to adjust the instruction value while visually checking the alignment result of the image and the paper by the user, thereby a user-specific demand is satisfied. On the other hand, in the case of automatically adjusting the instruction value, the instruction values are applied one by one to the paper P transported next to the paper P which has been used for the adjustment. This allows to flexibly address the humidity change due to a season.

As mentioned above, the embodiments have been described, but concrete constitutions are not limited to those described in the embodiments, and any change and any addition within the scope of the present invention are included in the present invention.

In the present embodiments, the instruction value to the shift amount ΔX is larger than the shift amount ΔX, but it is not limited to this manner. For example, in the case of thin paper or plain paper (paper which has a grammage smaller than that of thick paper), the instruction value can be a smaller value than the shift amount ΔX depending on the specification of an apparatus.

Moreover, in the present embodiments, groups are classified in accordance with the state of the paper in one side printing and both-sides printing respectively, but same group may be applied in both cases of one side printing and both-sides printing.

Further, in the present embodiments, the image forming apparatus which forms a color image on the paper is described, but the present invention may apply to an image forming apparatus which forms a monochrome image on the paper.

Moreover, in the present embodiments, the image forming apparatus of which image forming manner is an electrophotographic manner is explained, but the present invention may apply to an image forming apparatus with an ink-jet manner.

Moreover, the means and method for performing the various processes in the image forming apparatus 1 according to the present embodiments can be implemented by not only dedicated hardware circuit but also a programmed computer. The above-mentioned program may be provided by, for example, a computer-readable recording medium such as a flexible disk, CD-ROM and the like and may be provided on-line through networks such as Internet. In this case, the program recorded on a computer-readable medium is usually transmitted to and stored in a memory unit such as a hard disk. Moreover, the above-mentioned program may be provided as independent application software, and may be included in the software of the apparatus as a function of a printing system.

What is claimed is:

1. An image forming apparatus comprising:
an image forming unit to form an image on a paper in an image forming position;
a transportation path to transport the paper to the image forming position;
an acquisition unit arranged in upstream side of the image forming position in a paper transportation direction, and to acquire a shift amount from an edge reference position to an edge of the paper in a paper width direction perpendicular to the paper transportation direction;
a pair of resist rollers arranged in the upstream side of the acquisition unit in the paper transportation direction, and being capable of swinging in the paper width direction; and
a control unit configured to determine an instruction value based on a state of the paper and the shift amount before the pair of resist rollers moves, and to move the pair of resist rollers in accordance with the instruction value in the paper width direction.

2. The image forming apparatus as claimed in claim 1, wherein the state of the paper includes at least one of humidity of a place on which the image forming apparatus is set, grammage of the paper, paper size of the paper and shape of the paper at the time of acquiring the shift amount by the acquisition unit.

3. The image forming apparatus as claimed in claim 1, wherein the control section increases the instruction value as a frictional force generated between the paper and the transportation path increases.

4. The image forming apparatus as claimed in claim 1, further comprising:
a memory unit to store the instruction value; and
an adjusting unit to adjust the instruction value stored in the memory unit.

5. The image forming apparatus as claimed in claim 1, wherein the acquisition unit detects the shift amount of the paper which has been moved according to the instruction value by the pair of resist rollers, and the control section adjusts the instruction value based on the instruction value and the shift amount of the paper which has been moved according to the instruction value.
